(19) United States
(12) Patent Application Publication
(10) Pub. No.: US 2011/0309030 A1
(43) Pub. Date: Dec. 22, 2011

(54) APPARATUS FOR REMOVING HYDROCARBON CONTAMINANTS FROM A BODY OF WATER

(76) Inventor: Michael Dorman, County Antrim (GB)

(21) Appl. No.: 13/202,728

(22) PCT Filed: Feb. 12, 2010
(86) PCT No.: PCT/EP2010/000871

§ 371 Date: Aug. 22, 2011

(30) Foreign Application Priority Data
Feb. 23, 2009 (GB) GB0903011.5

(51) Int. Cl. C02F 1/40; E03F 5/16; B01D 21/30

(52) U.S. Cl. 210/742; 210/149; 210/138

(57) ABSTRACT

An apparatus and method for removing hydrocarbon contaminants from a body of water, comprising a skimming device having a driven skimming member arranged to be passed into and out of said body of water for collecting hydrocarbon contaminants, a temperature sensor for sensing the ambient temperature of the body of water and a control device for controlling operation of the skimming device in response to the output of the temperature sensor. The control device is programmed to operate the skimming device when the temperature sensor indicates that the ambient temperature of the mixture of hydrocarbon contaminants and water and/or the body of water and/or the hydrocarbon contaminants is at or above a predetermined minimum temperature such that the skimming device is operated during periodic increases in the temperature of the body of water without requiring additional heating means.

This invention relates to an apparatus for removing hydrocarbon contaminants from a body of water and in particular to an apparatus for removing grease and oil from water contained in a grease trap.

Grease trap assemblies are used in connection with commercial food preparation sinks, rinse sinks and dishwashing and utensil washing facilities in restaurants, fast food outlets, hospitals, hotels and other large kitchen facilities that produce grease and oil-laden wastewater. Grease traps are required in order to reduce the amount of grease, cooking oil and other contaminants that are introduced into the drains and ultimately the water treatment facilities serving the region. Grease traps are also used to remove oil from waste water used for coolant and lubricants in machine tools.

Such grease trap assemblies are well known and range in complexity from simple settling tanks, that require periodic manual grease removal, to rather complex structural arrangements that provide for automatic skimming and discharge of skimmed grease and oil into external containers positioned adjacent the trap assembly.

The simplest forms of grease traps are, in essence, simply an enclosed hollow settling tank having a wastewater inlet at one end and an outlet at an opposite end for connection to a drain. Often baffle plates are arranged within the tank to interrupt direct flow-through of wastewater between the inlet and the outlet. Periodically, an employee must manually skim the grease and oil that has accumulated at the surface of the wastewater. This is an extremely unpleasant and time consuming task.

Grease trap assemblies having automatic skimmer arrangements have also been provided, and typically utilize a rotating skimmer device, in the form of a disc, drum, endless belt or tube, mounted above the tank and connected to a drive arrangement to move the skimming device into and out of the water within the tank of the grease trap. The skimming device collect grease and oil from the surface of the water in the tank as it moves out of the water and is subsequently cleaned by means providing a scraping or squeezing action on the skimming device, such as wiper blades, arranged to direct grease and oil to a collection device before the skimming device passes back into the water.

Typically the skimming device is formed from an oleophilic and hydrophobic material, typically a flexible polymeric material in the form of an endless belt, band or tube that attracts oil and repels water, whereby the oil and grease sticks to the surfaces of the skimming device as it passes through the floating layer of oil and grease on top of the waste water in the tank of the grease trap.

Typically such skimmer arrangements are only able to be operated when the temperature of the mixture of oil, grease and water in the grease trap is sufficiently high such that the viscosity of the grease and oil, particularly more waxy greases, is sufficiently low to enable the skimming device to collect such grease and oil. Typically the temperature of the mixture need to be around 31° C. or above for the skimming device to remove grease effectively. At lower temperatures the grease can form a wax like skin on the surface of the water, preventing operation of the skimming device. Also, at lower temperatures the oil and grease flow more slowly such that, as the skimming device enters or leaves water body, the surface in the vicinity of belt entry soon becomes relatively oil free and further removal of oil is delayed due to the relatively slow migration of oil and grease from portions of the body surface remote from the entry and exit locations of the skimming device.

Therefore prior art automatic skimmer arrangements have required complex and costly heating arrangement, typically electrical immersion heaters, to heat the mixture of oil, grease and water to the required temperature. As well as being costly to operate in terms of electricity consumption, there is a risk of fire if the grease trap runs dry or if oil builds up on the heating element of the immersion heater. Also heat supplied by such known electrical immersion heaters may be difficult to control leading to overheating of the waste water within the grease trap. Localised water temperatures of over 60° C. often result from such heaters, at which temperature it may not be permitted to discharge the waste water into a drain.

According to the present invention there is provided an apparatus for removing hydrocarbon contaminants from a body of water, such as waste water within a grease trap, said apparatus comprising a skimming device, said skimming device having a driven skimming member arranged to be passed into and out of said body of water for collecting hydrocarbon contaminants, a temperature sensor for sensing the temperature of the body of water and a control device for controlling operation of the skimming device in response to the output of the temperature sensor, wherein the control device is programmed to operate the skimming device when the temperature sensor indicates that the ambient temperature of the mixture of hydrocarbon contaminants and water and/or the body of water and/or the hydrocarbon contaminants is at or above a predetermined minimum temperature such that the skimming device is operated during periodic increases in the ambient temperature of the body of water without requiring additional heating means.

The term “ambient” defines the inherent temperature of the body of water devoid of any “additional” heating beyond that occurring as a result of the temperature of the water entering the apparatus. By contrast, prior art systems require additional heaters to control the temperature of the body of water during a skimming operation. Such prior art systems do not envisage the control of the skimming device based upon the ambient temperature of the body of water such that the skimming device is operated periodically in response to inherent increases in the temperature of the body of water.

Thus the present invention enables effective operation of the skimming device utilising the ambient temperature of the body of water without requiring any additional heating of the body of water, instead utilising fluctuations in the ambient temperature of the body of water to operate the skimming device at times when the temperature is high enough to permit efficient operation of the skimming device, for example when warm water from a washing operation is passed into the grease trap.

Preferably the skimming device further comprises a wiper device for removing grease and oil from the skimming member by a wiping and/or squeezing action and delivering the oil and grease to a collection means

The skimming member of the skimming device may comprise a disc, drum or an elongate endless member, such as a belt or tube, arranged to be partially submerged in the body of water.

The skimming device may be mounted on a frame or housing detachably mountable on a tank containing said body of body.

The skimming device and the control means may be powered by one or more batteries. Alternatively the skimming device and control means may be connectable to an external power supply, such as a mains electricity supply.

In one embodiment the skimming member of the skimming device comprises an elongate flexible tube or pipe defining an endless loop, said tube being mounted on one or more guides wheels, at least one guide wheel being driven, said tube being positioned to dip into the body of water and to be moved through the body of water from an entry location to leave the body of water at an exit location.

Said tube may be provided with an elongate slit extending along its length, preferably parallel to the longitudinal axis of the tube, such that the tube can collect oil and grease on both its inner and outer surfaces. A slit opening device may be provided at or adjacent the entry and/or exit location of the tube in the body of water to open said elongate slit at said entry and/or exit location. The slit opening device may be mounted on a float and/or may be mounted at a distal end of an elongate tube guide. The slit opening device may comprise a tube guide member having an enlarged distal head portion adapted to be located within the tube and a relatively narrow supporting portion adapted to pass through the elongate slit and open up the slit at said entry and/or exit location.

Preferably said control device is associated with or incorporates a timer whereby the control device can be programmed to operate the skimming device as a function of both time and the temperature sensed by temperature sensor. Preferably the control device is programmed to operate the skimming device when the temperature sensor indicates that the temperature of the mixture of hydrocarbon contaminants and water and/or the body of water and/or the hydrocarbon contaminants is at or above a predetermined minimum temperature, for example 31° C. Preferably the control device is programmed to check the temperature of the body of water at predetermined time intervals or at preset times and to operate the skimming device if the temperature of the body of water is above said predetermined minimum value. The control device may be programmed to operate the skimming device after a predetermined period of inactivity regardless of the temperature of the body of water.

For example, the control device may be programmed to operate the skimming device at a number of predetermined times during the day, roughly corresponding to expected periods of use of equipment supplying waste water to the grease trap. During such periods, the control device can be programmed to operate the skimming device only if the temperature sensor determines that the temperature of the body of water is sufficiently high for the skimming device to function correctly. The control device can be programmed to operate the skimming device for a predetermined period, for example 2 minutes. However, to avoid the formation of a skin or crust on the surface of the body of water during long periods of inactivity, the control device can be programmed to operate the skimming device after a predetermined period of inactivity, regardless of the temperature of the body of water.

Thus the skimming device can take advantage of periodic increases in the ambient temperature of the body of water, for example due to operational factors such as the passage of hot waste water into the grease trap from washing operations and can utilise such external “waste” heat to carry out efficient skimming operations, thus avoiding the need for any additional heating means.

According to a further aspect of the present invention there is provided a method of removing hydrocarbon contaminants from a body of water comprising providing a skimming device having a driven skimming member arranged to be passed into and out of said body of water for collecting hydrocarbon contaminants thereon, providing a temperature sensor for sensing the ambient temperature of the body of water and operating the skimming device in response to the output of the temperature sensor, such that the skimming device is operated during periodic increases in the ambient temperature of the body of water without requiring additional heating means.

Preferably the method comprises operating the skimming device when the temperature of the body of water exceeds a predetermined minimum value. In a preferred embodiment, the method comprises determining the temperature of the body of water at preselected time intervals or at preset times and operating the skimming device when the determined temperature is above said predetermined minimum value. Preferably the method comprises the further step of operating the skimming device after a predetermined period of inactivity of the skimming device regardless of the temperature of the body of water to avoid the formation of a crust of oil and grease on the surface of the body of water.

According to a further aspect of the present invention there is provided an apparatus for removing hydrocarbon contaminants from a body of water, said apparatus comprising a vessel or tank receiving said body of water, said vessel or tank having an inlet and an outlet, a skimming device being mounted on said vessel or tank, said skimming device having a driven skimming member arranged to be passed into and out of said body of water within the vessel or tank for collecting hydrocarbon contaminants, a temperature sensor for sensing the temperature of the body of water within said vessel or tank, and a control device for controlling operation of the skimming device in response to the output of the temperature sensor, wherein the control device is programmed to operate the skimming device when the temperature sensor indicates that the temperature of body of water is at or above a predetermined minimum temperature such that the skimming device is operated during periodic increases in the temperature of the body of water due to the temperature of the water entering the inlet of the vessel or tank.

The present invention provides a skimming apparatus which is well adapted for inclusion in original manufacture of a complete grease trap assembly, but the invention is also particularly well adapted for retrofitting and upgrading existing, already installed and in use manual skimming trap assemblies into automatic skimming apparatus as will become readily apparent.

An embodiment of the present invention will now be described with reference to the accompanying drawings, in which:

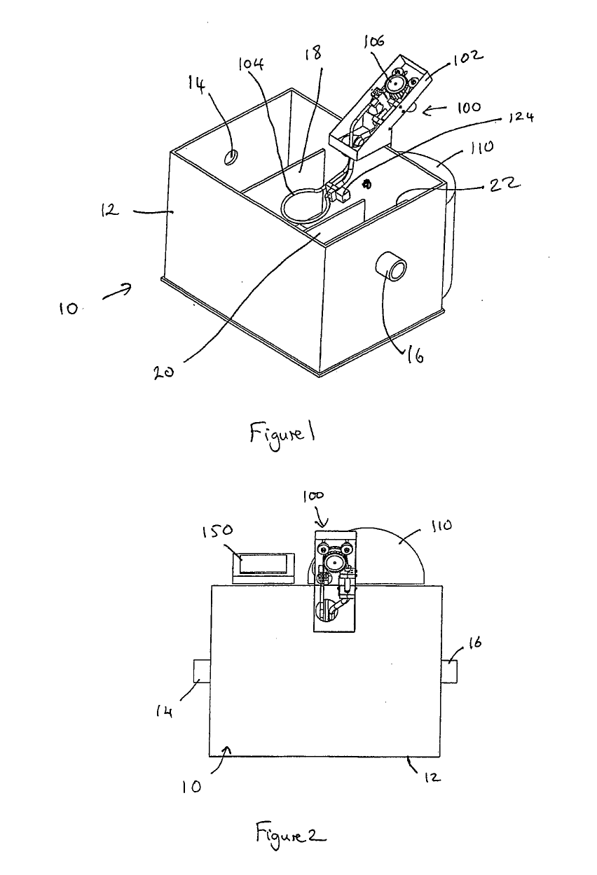

FIG. 1 is a perspective view of a grease trap apparatus having a grease removal device according to any embodiment of the present invention;

FIG. 2 is a plan view of the apparatus of FIG. 1;

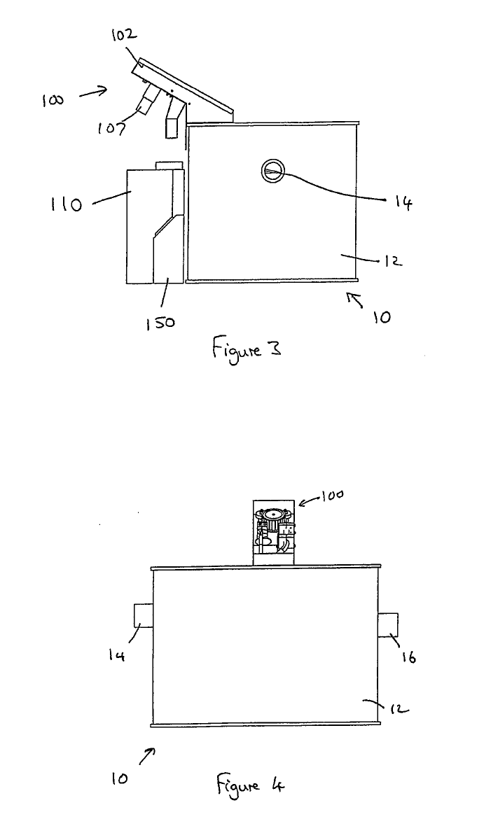

FIG. 3 is a side view of the apparatus of FIG. 1;

FIG. 4 is a front view of the apparatus of FIG. 1;

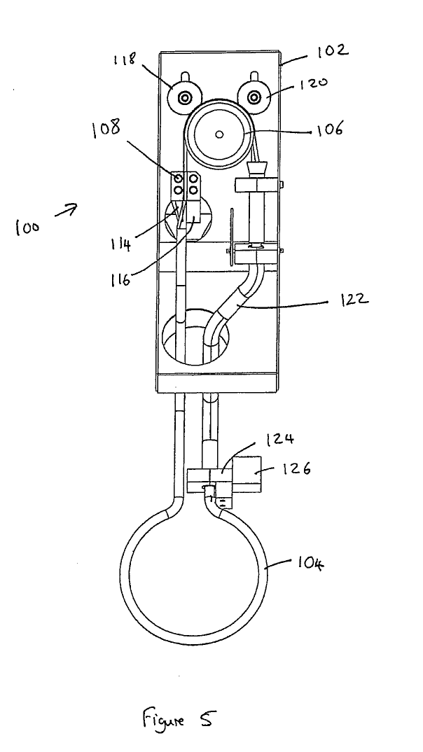

FIG. 5 is a detailed plan view of the grease removal device of the apparatus of FIG. 1;

FIG. 6 is a front view of the apparatus of FIG. 1;

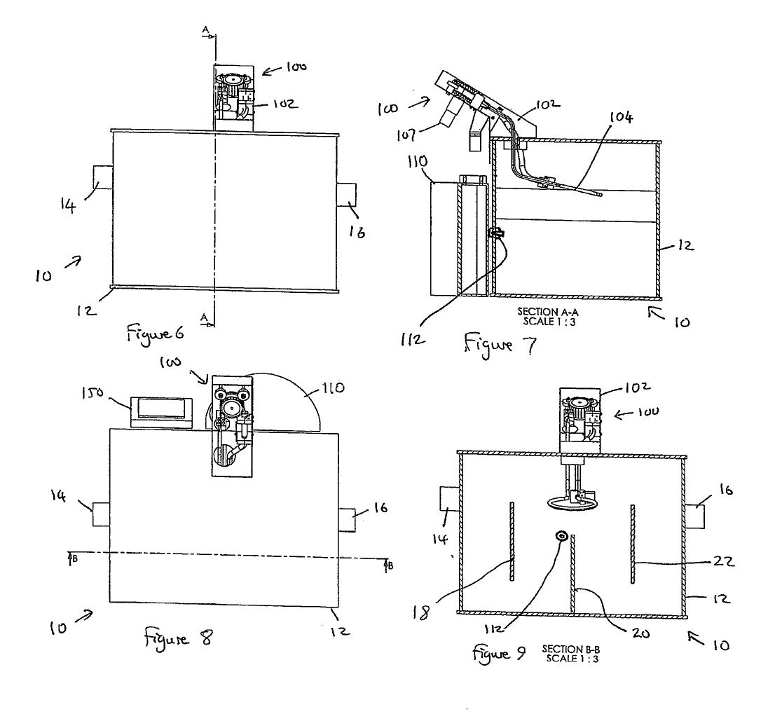

FIG. 7 is a sectional view on line A-A of FIG. 6;

FIG. 8 is a plan view of the apparatus of FIG. 1;

FIG. 9 is a sectional view on line B-B of FIG. 1;

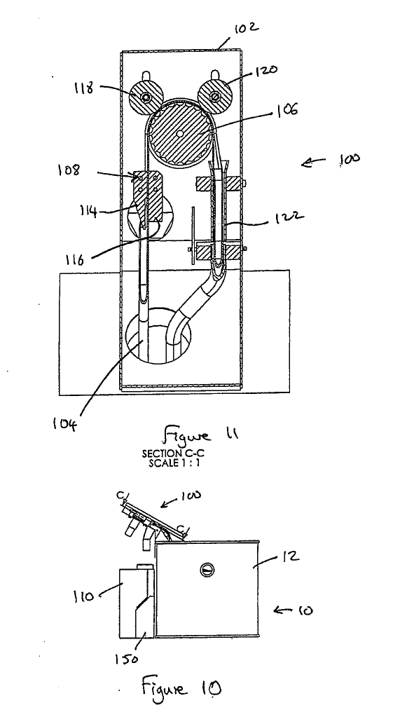

FIG. 10 is a side view of the apparatus of FIG. 1; and

FIG. 11 is a sectional view on line C-C of FIG. 10.

A grease trap 10 having a skimming device 100 according to an embodiment of the present invention is illustrated in the drawings.

The grease trap 10 comprising a tank 12 having a wastewater inlet 14 at one end and a wastewater outlet 16 at an opposite end. Baffle plates 18,20,22 are provided within the tank, extending transverse to the normal direction of flow of water between the wastewater inlet 14 and the outlet 16 to interrupt direct flow-through of wastewater between the inlet 14 and the outlet 16. At least the wastewater outlet 16 is positioned to be below the normal level of water within the tank 12 such that only clean water passes out of the wastewater outlet 16, any oil and grease being maintained on the surface of the water within the tank 12.

To remove the collected oil and grease from the surface of the body of water within the tank 12, a skimming device 100 comprises a housing 102 mounted on an upper side of the grease trap 10. Alternatively the housing 102 of the skimming device 100 may be mounted on the cover of the grease trap 100.

The skimming device 100 comprises a flexible endless tube 104 formed from an oleophilic and hydrophobic polymeric material, the tube 104 being mounted to extend out of the housing 102 to dip into the body of water within the tank 12 of the grease trap 10. The tube 104 is guided to pass around a drive roller 106 within an upper region of the housing 102, said drive roller 106 being rotatable by an electric motor (107, FIG. 3) to move the tube through the body of water within the tank 12 to collect any oil and grease lying on the surface of the body of water. When driven by the drive roller 106, the tube passes through the body of water and subsequently passes through a scraper 108 mounted within housing 102 whereby oil and grease collected on the tube 104 is scraped off and passed out of an outlet in the housing 102 to be received in a collection vessel 110.

The operation of the skimming device 100 is controlled by a control device 150 having a timer whereby the control device can be programmed to operate the skimming device a predetermined intervals throughout the day, typically corresponding to periods of peak usage of the grease trap 10. The control device 150 may be a microelectronic controller. A temperature sensor 112 is provided in for determining the ambient temperature of the body of water within the tank 12. The temperature may be mounted at any suitable location where it is capable of sensing the temperature of the body of water contained within the tank, for example in a cover of the tank or on the side of the tank 12, as shown in the drawings. In a preferred embodiment (not shown) the temperature sensor may be mounted on the skimming device 100. While the control device 150 is shown attached to the side of the grease trap, it may preferably be incorporated into the skimming device, preferably within the housing 102 of the skimming device or attached thereto, so that the skimming device 100 comprises a self contained unit incorporating both the control device 150 and the temperature sensor 112, allowing the apparatus to be readily retrofitted to an existing passive grease trap. Alternatively the control device 150 may be mounted on the cover of the grease trap.

The control device 150 is connected to the temperature sensor 112 whereby the control device 150 can be programmed to activate the skimming device 100 when the ambient temperature of the body of water in the tank 12, as determined by the temperature sensor 112, exceeds a predetermined minimum necessary for efficient operation of the skimming device, typically around 31° C.

Thus the control device 150 can be programmed to take advantage of periodic fluctuations in the ambient temperature of the body of water due to external factors, such as the passage of hot waste water from dishwashers or other washing operations, into the grease trap 10, enabling the skimming device 100 to be operated when the temperature sensor 112 detects such increases in temperature, avoiding the need for any additional heating means within the grease trap itself.

For example, the control device 150 may be programmed to check the ambient temperature of the body of water by means of the temperature sensor at intervals during a predetermined operating window at certain times of the day and to operate the skimming device for a predetermined period of time when the detected temperature of the body of water exceeds said predetermined minimum.

In order to prevent the formation of a crust on the surface of the body of water in the grease trap, the control device 150 may be programmed to operate the skimming device 100 for a period of time if the skimming device 100 has not been operated for a predetermined interval, even if the temperature of the body of water has not reached the predetermined minimum during such predetermined interval.

In an optional modification, to further enhance the efficiency of the skimming device, the tube 104 may be provided with an elongate axial slit along its length such that both the inner and outer surface of the tube can be exposed to oil and grease within the grease trap, effectively doubling the surface area available for the collection of oil and grease while maintaining the advantages inherent in the use of a flexible tube, such as enhanced flexibility and greater freedom of movement compared to a belt.

As best seen from FIGS. 5 and 11, in order to clean both the inner and outer surfaces of the tube 104, the scraper 108 may be adapted to open up and flatten out the tube 104, the scraper 108 having first and second opposing scraping members 114,116 between which the opened and flattened tube is forced to pass, the first scraping member having a pointed leading end arranged to open up the tube as it is pulled through the scraper 108 by the drive roller 106. Idler wheels 118,120 are provided at spaced locations around the periphery of the drive roller 106 to improve grip between the drive roller 108 and the tube 104 and to maintain the tube in its opened and flattened configuration as it passes around the drive roller 106.

Downstream of the drive roller 106 the tube 104 may pass through an elongate guide 122, guiding its passage back into the body of water. A tube opening device 124 may be provided at a distal end of the guide 122, the tube opening device 124 comprises a member having an enlarged distal head adapted to be located within the tube 104 and a relatively narrow supporting portion adapted to pass through the elongate slit and open up the tube 104 at the entry of the tube 104 into the oil and grease layer lying on top of the body of water.

The tube opening device 124 may be provided with a float 126 such that the tube opening device 124 is maintained at the correct location at the surface of the body of water regardless of the level of water within the tank 12 of the grease trap 10.

The tube opening device 124 causes the tube slit to be opened up as the tube enters the body of water such that tube provides a biting or cutting action on the surface of the body of water whereby any congealed skin or crust on the surface of the body of water may be broken up. Such biting action may also cause solid food particles floating upon the surface of the body of water to be picked up and trapped within the tube.

Alternatively the tube of the skimming device may comprise a simple endless tube or flexible member passing around a drive roller to dip into and be dragged through the body of water within the tank 12, the tube passing through a tight fitting scraper adjacent an outlet of the housing 102 of the skimming device 100 to deliver the collected grease and oil into a suitable collection vessel.

While the present invention has been described in relation to a skimming apparatus for a grease trap for removing grease and oil from waste water, typically from catering washing facilities, the apparatus according to the present invention may be equally suitable for any other application wherein it is desired to remove oil or grease or any other immiscible liquid or fluid from the surface of denser liquid, such as water, for example for removing oil from waste or bilge water on a ship or similar vessel to allow the water to be discharged into the sea or in any other industrial process wherein it is desired to separate a mixture of immiscible fluids, particularly for removal of an immiscible fluid from the surface of a denser liquid where said immiscible fluid tends to form a skin or waxy layer on the surface of said denser liquid when below a certain temperature, the apparatus enabling a skimming device to be operated when the temperature of the mixture of fluids is above a minimum temperature required for efficient operation of the skimming device, taking advantage of periodic increases in the temperature of the mixture due to the temperature of incoming liquid withour requiring any additional heating.

The invention is not limited to the embodiment(s) described herein but can be amended or modified without departing from the scope of the present invention.

1. An apparatus for removing hydrocarbon contaminants from a body of water, said apparatus comprising a skimming device, said skimming device having a driven skimming member arranged to be passed into and out of said body of water for collecting hydrocarbon contaminants, a temperature sensor for sensing the ambient temperature of the body of water and a control device for controlling operation of the skimming device in response to the output of the temperature sensor, wherein the control device is programmed to operate the skimming device when the temperature sensor indicates that the temperature of the mixture of hydrocarbon contaminants and water and/or the body of water and/or the hydrocarbon contaminants is at or above a predetermined minimum temperature such that the skimming device is operated during periodic increases in the temperature of the body of water without requiring additional heating means.

2. An apparatus as claimed in claim 1, wherein said control device is associated with or incorporates a timer whereby the control device can be programmed to operate the skimming device as a function of both time and the temperature sensed by temperature sensor.

3. An apparatus as claimed in claim 2, wherein the control device is programmed to check the temperature of the body of water at predetermined time intervals or at preset times and to operate the skimming device if the temperature of the body of water is above said predetermined minimum value.

4. An apparatus as claimed in claim 2, wherein the control device is programmed to operate the skimming device after a predetermined period of inactivity, regardless of the temperature of the body of water.

5. An apparatus as claimed in claim 1, wherein the skimming device includes a wiper device for removing grease and oil from the skimming member by a wiping and/or squeezing action and delivering the oil and grease to a collection device.

6. An apparatus as claimed in claim 1, wherein the skimming member of the skimming device comprises a disc, drum or an elongate endless member, such as a belt or tube, arranged to be partially submerged in the body of water.

7. An apparatus as claimed in claim 1, wherein the skimming device is mountable on a tank containing said body of body.

8. An apparatus as claimed in claim 7, wherein said tank is provided with an inlet communicating with a source of contaminated water, such one or more washing devices or sinks, whereby the control unit operates the skimming device when the water entering the inlet of the tank is at a temperature at or above said predetermined minimum temperature.

9. An apparatus as claimed in claim 8, wherein the tank is provided with a drain outlet, the drain outlet being arranged to be located beneath the level of water in the tank during normal use.

10. An apparatus as claimed in claim 1, wherein the control device and the temperature sensor are mounted the skimming device to define a self contained unit that may be mounted on a tank or other reservoir containing said body of water.

11. An apparatus as claimed in claim 1, wherein the skimming device and the control means are powered by one or more batteries.

12. An apparatus as claimed in claim 1, wherein the skimming device and control means are connectable to an external power supply, such as a mains electricity supply.

13. An apparatus as claimed in claim 1, wherein the skimming member of the skimming device comprises an elongate flexible tube or pipe defining an endless loop, said tube being mounted on one or more guides wheels, at least one guide wheel being driven, said tube being positioned to dip into the body of water and to be moved through the body of water from an entry location to leave the body of water at an exit location.

14. A method of removing hydrocarbon contaminants from a body of water comprising providing a skimming device having a driven skimming member arranged to be passed into and out of said body of water for collecting hydrocarbon contaminants thereon, providing a temperature sensor for sensing the ambient temperature of the body of water and operating the skimming device in response to the output of the temperature sensor, such that the skimming device is operated during periodic increases in the temperature of the body of water without requiring additional heating means.

15. A method as claimed in claim 14, wherein the method comprises operating the skimming device when the temperature of the body of water exceeds a predetermined minimum value.

16. A method as claimed in claim 15, comprising determining the temperature of the body of water at preselected time intervals or at preset times and operating the skimming device when the determined temperature is above said predetermined minimum value.

17. A method as claimed in claim 16, wherein the method comprises the further step of operating the skimming device after a predetermined period of inactivity of the skimming device regardless of the temperature of the body of water to avoid the formation of a crust of oil and grease on the surface of the body of water.

18. An apparatus for removing hydrocarbon contaminants from a body of water, said apparatus comprising a vessel or tank receiving said body of water, said vessel or tank having an inlet and an outlet, a skimming device being mounted on said vessel or tank, said skimming device having a driven skimming member arranged to be passed into and out of said body of water within the vessel or tank for collecting hydrocarbon contaminants, a temperature sensor for sensing the temperature of the body of water within said vessel or tank, and a control device for controlling operation of the skimming device in response to the output of the temperature sensor, wherein the control device is programmed to operate the skimming device when the temperature sensor indicates that the temperature of body of water is at or above a predetermined minimum temperature such that the skimming device is operated during periodic increases in the temperature of the body of water due to the temperature of the water entering the inlet of the vessel or tank.

19. An apparatus as claimed in claim 2, wherein the skimming member of the skimming device comprises a disc, drum or an elongate endless member, such as a belt or tube, arranged to be partially submerged in the body of water.

20. An apparatus as claimed in claim 2, wherein the skimming member of the skimming device comprises an elongate flexible tube or pipe defining an endless loop, said tube being mounted on one or more guides wheels, at least one guide wheel being driven, said tube being positioned to dip into the body of water and to be moved through the body of water from an entry location to leave the body of water at an exit location.
